(19) United States
(12) Patent Application Publication
(10) Pub. No.: US 2025/0096431 A1
(43) Pub. Date: Mar. 20, 2025

(54) POWER STORAGE CELL

(71) Applicant: TOYOTA JIDOSHA KABUSHIKI KAISHA, Toyota-shi (JP)

(72) Inventors: Kazuhito KATO, Toyota-shi (JP); Junta TAKASU, Nagoya-shi (JP); Atsushi Yamanaka, Nagoya-shi (JP); Masato Ono, Nagoya-shi (JP); Satoshi Moriyama, Nagoya-shi (JP); Kosuke Suzuki, Toyota-shi (JP); Kazuki Sugie, Miyoshi-shi (JP); Kazuya Kumazawa, Nagoya-shi (JP)

(73) Assignee: TOYOTA JIDOSHA KABUSHIKI KAISHA, Toyota-shi (JP)

(21) Appl. No.: 18/644,632

(22) Filed: Apr. 24, 2024

(30) Foreign Application Priority Data
Sep. 20, 2023 (JP) 2023-152123

(51) Int. Cl. H01M 50/528; H01M 10/04; H01M 50/107; H01M 50/169

(52) U.S. Cl. CPC H01M 50/528; H01M 10/0431; H01M 50/107; H01M 50/169

(57) ABSTRACT

In a power storage cell according to the present disclosure, the first electrode of the wound electrode assembly includes a sheet-shaped current collector and an electrode composite material layer formed on the current collector. The current collector includes a coated portion on which the electrode composite material layer is coated and an uncoated portion on which the electrode composite material layer is not coated. The uncoated portion protrudes from the coated portion to one side in the axial direction of the wound electrode assembly. The case houses the wound electrode assembly, and includes a cylindrical wall portion and a bottom portion. The cylindrical wall portion is provided so as to cover the outer peripheral side of the wound electrode assembly. The bottom portion is disposed on one side in the axial direction, connected to one end of the cylindrical wall portion, and joined to the uncoated portion by welding.

### CROSS-REFERENCE TO RELATED APPLICATION

This application claims priority to Japanese Patent Application No. 2023-152123 filed on Sep. 20, 2023, incorporated herein by reference in its entirety.

### BACKGROUND

### 1. Technical Field

The present disclosure relates to a power storage cell.

### 2. Description of Related Art

Japanese Unexamined Patent Application Publication No. 10-162854 (JP 10-162854 A) discloses a cylindrical battery including a spiral electrode group and having a tab-less current collecting system. One substantially disc-shaped current collector is welded to the conductive edge of an anode plate protruding outward from each of the upper and lower end faces of the electrode group.

### SUMMARY

In a power storage cell such as the cylindrical battery disclosed in JP 10-162854 A, there is room to further reduce the number of components and further improve the energy density per unit volume of the cell.

The present disclosure has been made in view of the above issue, and an object thereof is to provide a power storage cell with further improved energy density.

A power storage cell according to the present disclosure includes a wound electrode assembly and a case.

The wound electrode assembly includes a wound first electrode and a wound second electrode.

The first electrode includes a sheet-shaped current collector and an electrode composite material layer provided on the current collector.

The current collector includes a coated portion that is coated with the electrode composite material layer, and an uncoated portion that is not coated with the electrode composite material layer.

The uncoated portion protrudes from the coated portion to one side in an axial direction of the wound electrode assembly.

The case houses the wound electrode assembly. The case includes a cylindrical wall portion and a bottom portion.

The cylindrical wall portion is provided to cover an outer peripheral side of the wound electrode assembly.

The bottom portion is disposed on the one side in the axial direction and connected to one end of the cylindrical wall portion.

The bottom portion is joined to the uncoated portion by welding from an outside of the case.

According to the above configuration, the bottom portion of the case has a current collecting function of the first electrode. Therefore, a current collector plate that is a member different from the case is not required for the first electrode, and the number of components of the power storage cell can be reduced. Thus, the case has a larger space that can house the wound electrode assembly, and a larger wound electrode assembly can be housed. As a result, the energy density of the power storage cell is further improved.

According to the present disclosure, it is possible to provide the power storage cell with further improved energy density.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view illustrating a power storage cell according to a first embodiment;

FIG. 2 is a perspective view of the wound electrode assembly partially exploded;

FIG. 3 is an exploded perspective view illustrating a power storage cell according to the first embodiment;

FIG. 4 is another exploded perspective view showing a power storage cell according to Embodiment 1; and

FIG. 5 is a cross-sectional view of a power storage cell according to a second embodiment.

### DETAILED DESCRIPTION OF EMBODIMENTS

Hereinafter, a power storage cell according to each embodiment of the present disclosure will be described with reference to the drawings. The same or corresponding parts in the drawings are denoted by the same reference numerals, and the description thereof will not be repeated.

### First Embodiment

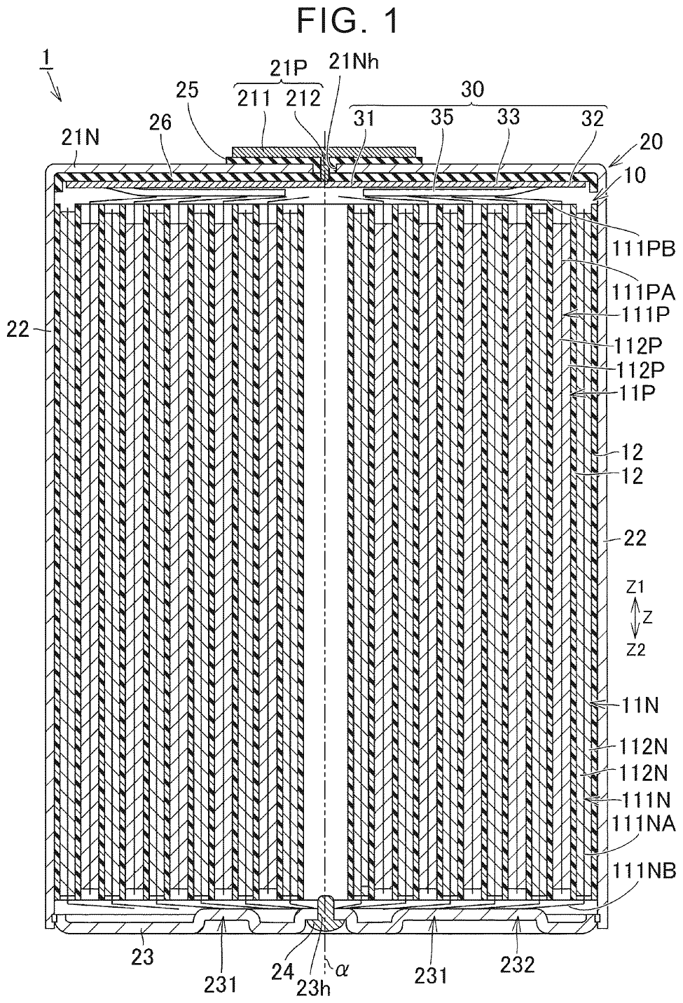

FIG. 1 is a cross-sectional view illustrating a power storage cell according to a first embodiment. As illustrated in FIG. 1, a power storage cell 1 according to a first embodiment of the present disclosure includes a wound electrode assembly 10, a case 20, and a positive electrode current collector plate 30.

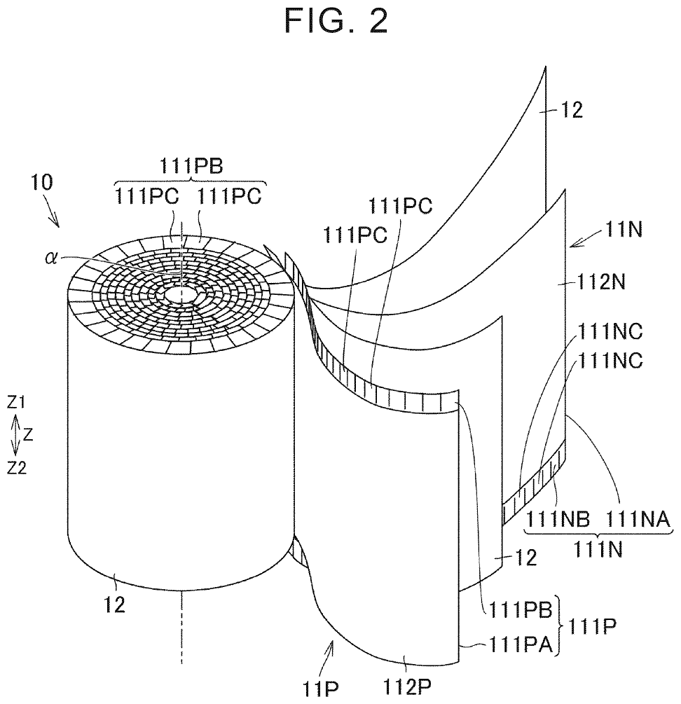

First, the wound electrode assembly 10 will be described. FIG. 2 is a partially exploded perspective view of the wound electrode assembly. As shown in FIGS. 1 and 2, the wound electrode assembly 10 is wound so as to have a cylindrical shape. FIG. 2 illustrates a state in which the winding of the wound electrode assembly 10 is slightly unwound.

The wound electrode assembly 10 includes a positive electrode 11P, a negative electrode 11N, and separators 12. In the first embodiment, a negative electrode 11N is exemplified as the first electrode, and a positive electrode 11P is exemplified as the second electrode. The first electrode may be a positive electrode and the second electrode may be a negative electrode.

The positive electrode 11P and the negative electrode 11N have a sheet-like outer shape. The wound electrode assembly 10 includes an electrode plate group in which a positive electrode 11P and a negative electrode 11N are wound with separators 12 interposed therebetween.

The separators 12 are provided between the positive electrode 11P and the negative electrode 11N. The separators 12 separate the positive electrode 11P and the negative electrode 11N while allowing ions (e.g., lithium ions) to move back and forth between the positive electrode 11P (positive electrode active material) and the negative electrode 11N (negative electrode active material).

The positive electrode 11P includes a positive electrode current collector 111P and a positive electrode mixture 112P. The positive electrode current collector 111P is made of, for example, aluminum.

The positive electrode mixture layers 112P are coated on both radial surfaces of a positive electrode current collector 111P (a positive electrode coated portion 111PA described later). The positive electrode mixture layers 112P are in close contact with the separators 12. The positive electrode mixture layers 112P are formed by coating a positive electrode slurry on the positive electrode current collector 111P and drying the positive electrode slurry. The positive electrode slurry is a slurry prepared by kneading a material (a positive electrode active material, a binder, or the like) on 112P of the positive electrode mixture layers and solvents. The thickness of the positive electrode mixture 112P is, for example, 0.1 μm or more and 1000 μm or less.

The positive electrode current collector 111P includes a positive electrode coated portion 111PA and a positive electrode uncoated portion 111PB. The positive electrode coated portion 111PA is a portion of the positive electrode current collector 111P on which the positive electrode mixture layers 112P are coated. In other words, the positive electrode coated portion 111PA is a portion that is not exposed by being covered with the positive electrode mixture layer 112P.

The positive electrode uncoated portion 111PB is a portion of the positive electrode current collector 111P that is not covered with the positive electrode mixture layers 112P and is exposed. The positive electrode uncoated portion 111PB is located closer to the first direction Z1 along the axial direction Z than the positive electrode coated portion 111PA. Specifically, the positive electrode uncoated portion 111PB protrudes from the positive electrode coated portion 111PA toward the first direction Z1. The positive electrode uncoated portion 111PB is bent radially inward about the winding axial line a.

The positive electrode uncoated portion 111PB includes a plurality of extending portions 111PC. The plurality of extending portions 111PC are arranged along the winding direction of the wound electrode assembly 10.

The negative electrode 11N includes a negative electrode current collector 111N and a negative electrode mixture 112N. In the first embodiment, the negative electrode current collector 111N is exemplified as the current collector in the present disclosure, and the negative electrode mixture layer 112N is exemplified as the electrode composite material layer in the present disclosure.

The negative electrode current collector 111N has a sheet-like outer shape. The negative electrode current collector 111N is made of, for example, copper.

The negative electrode mixture layers 112N are formed on the negative electrode current collector 111N. Specifically, the negative electrode mixture layers 112N are coated on both radial surfaces of the negative electrode current collector 111N (a negative electrode coated portion 111NA described later). The negative electrode mixture layers 112N are in close contact with the separators 12. The negative electrode mixture layers 112N are formed by coating the negative electrode slurry on the negative electrode current collector 111N and drying the negative electrode slurry. The negative electrode slurry is a slurry prepared by kneading a material (a negative electrode active material, a binder, or the like) on 112N of the negative electrode mixture layers and solvents. The thickness of the negative electrode mixture 112N is, for example, 0.1 μm or more and 1000 μm or less.

The negative electrode current collector 111N includes a negative electrode coated portion 111NA and a negative electrode uncoated portion 111NB. The negative electrode coated portion 111NA is a portion of the negative electrode current collector 111N on which the negative electrode mixture layer 112N is coated. In other words, the negative electrode coated portion 111NA is a portion that is not exposed by being covered with the negative electrode mixture layer 112N.

The negative electrode uncoated portion 111NB is a portion where the negative electrode mixture layer 112N is not coated. In other words, the negative electrode uncoated portion 111NB is a portion of the negative electrode current collector 111N that is not covered by the negative electrode mixture layers 112N and is exposed. The negative electrode uncoated portion 111NB is located on the second direction Z2 side along the axial direction with respect to the negative electrode coated portion 111NA. The second direction Z2 is opposite the first direction Z1. The negative electrode uncoated portion 111NB protrudes from the negative electrode coated portion 111NA toward one side in the axial direction Z of the wound electrode assembly 10. Specifically, the negative electrode uncoated portion 111NB protrudes from the negative electrode coated portion 111NA toward the second direction Z2 along the axial direction Z. The negative electrode uncoated portion 111NB is bent radially inward about the winding axial line a.

The negative electrode uncoated portion 111NB includes a plurality of extending portions 111NC. The plurality of extending portions 111NC are arranged along the winding direction of the wound electrode assembly 10.

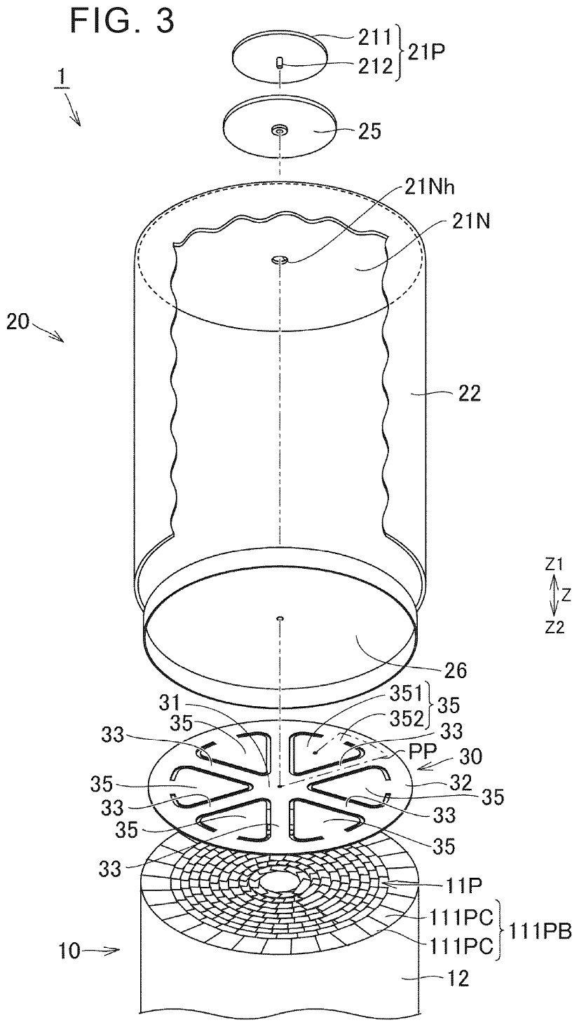

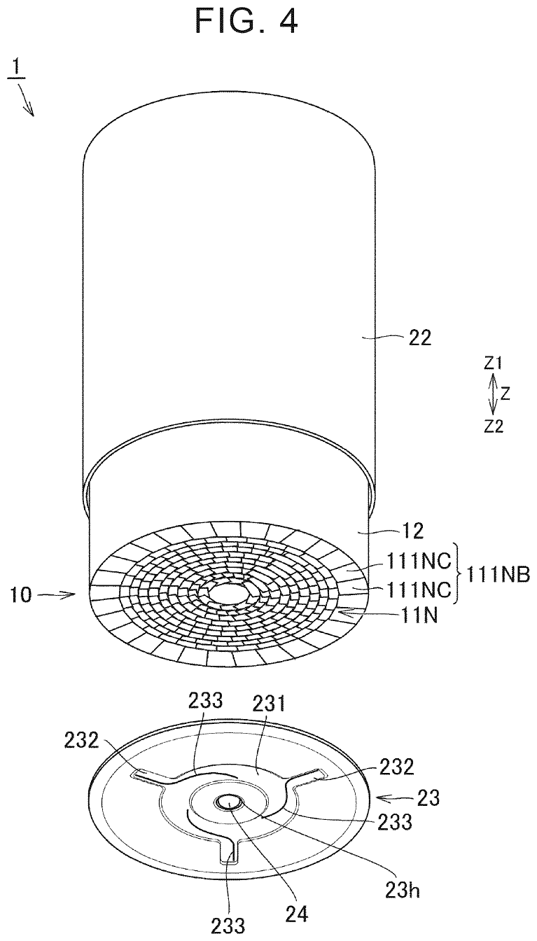

Next, the case 20 will be described. FIG. 3 is an exploded perspective view illustrating a power storage cell according to the first embodiment. FIG. 4 is another exploded perspective view illustrating a power storage cell according to the first embodiment.

As illustrated in FIGS. 1, 3, and 4, the case 20 houses the wound electrode assembly 10. The case 20 includes a positive electrode terminal 21P, a negative electrode terminal 21N, a cylindrical wall portion 22, a bottom portion 23, a sealing plug 24, an outer gasket 25, and an inner gasket 26. In the present embodiment, the negative electrode terminal 21N is exemplified as the external terminal in the present disclosure.

The positive electrode terminal 21P is disposed Z1 the wound electrode assembly 10 in the first direction. The positive electrode terminal 21P includes a disc portion 211 and a rivet portion 212. The disc portion 211 is exposed to the outside. The rivet portion 212 is connected to the disc portion 211. The rivet portion 212 extends from the center of the disc portion 211 when viewed in the axial direction Z. The rivet portion 212 is located approximately on the winding axis a of the wound electrode assembly 10. The rivet portion 212 extends Z2 the second direction. The positive electrode terminal 21P is made of, for example, aluminum.

The negative electrode terminal 21N is provided so as to be perpendicular to the axial direction Z. The negative electrode terminal 21N is provided with a through-hole 21Nh. Therefore, the negative electrode terminal 21N has a ring-shaped outer shape when viewed from the axial direction Z. The negative electrode terminal 21N is positioned between the disc portion 211 and the wound electrode assembly 10 in the axial direction Z. The rivet portion 212 is inserted through the through-hole 21Nh. The rivet portion 212 extends to the inside of the case 20. The negative electrode terminal 21N is made of aluminum, copper, stainless steel, or the like.

The cylindrical wall portion 22 is provided so as to cover the outer peripheral side of the wound electrode assembly 10. The cylindrical wall portion 22 covers the entire outer peripheral side of the wound electrode assembly 10. The cylindrical wall portion 22 has a cylindrical shape. An end portion of the cylindrical wall portion 22 Z1 to the first direction is connected to the negative electrode terminal 21N. The negative electrode terminal 21N is integrally formed with the cylindrical wall portion 22. The material constituting the cylindrical wall portion 22 is not particularly limited, but is made of a conductive material such as aluminum, copper, or stainless steel.

The bottom portion 23 is disposed on one side in the axial direction Z as viewed from the wound electrode assembly 10. When the negative electrode terminal 21N is connected to the other end of the cylindrical wall portion 22, it can be said that the bottom portion 23 is connected to one end of the cylindrical wall portion 22. Specifically, the bottom portion 23 is connected to the second direction Z2 end portion of the cylindrical wall portion 22.

The bottom portion 23 seals the opening of the cylindrical wall portion 22 Z2 the second direction. The bottom portion 23 is a sealing plate. The bottom portion 23 is welded to the cylindrical wall portion 22 so that the negative electrode 11N is electrically connected to the negative electrode terminal 21N via the bottom portion 23 and the cylindrical wall portion 22. The outer peripheral edge of the bottom portion 23 is connected to the cylindrical wall portion 22 by welding such as laser welding. The material constituting the bottom portion 23 is not particularly limited, but is made of a conductive material such as aluminum, copper, or stainless steel.

The bottom portion 23 is joined to the negative electrode uncoated portion 111NB by welding from the outer side of the case 20. As a result, the bottom portion 23 is negatively charged. The cylindrical wall portion joined to the bottom portion 23 is also negatively charged. The negative electrode terminal 21N connected to the cylindrical wall portion 22 is also negatively charged. Note that the bottom portion 23 of the power storage cell 1 can also be used as a negative electrode terminal.

The bottom portion 23 includes an annular ridge portion 231, a plurality of radial ridge portions 232, and a plurality of welded portions 233. The annular ridge portion 231 extends annularly around the winding axis a of the wound electrode assembly 10 when viewed in the axial direction Z. The annular ridge portion 231 protrudes toward the first direction Z1. That is, the annular ridge portion 231 protrudes toward the wound electrode assembly 10. The annular ridge portion 231 is in contact with the negative electrode uncoated portion 111NB of the negative electrode 11N.

The plurality of radial ridge portions 232 are arranged so as to be spaced apart from each other in the circumferential direction around the winding axis a of the wound electrode assembly 10 when viewed in the axial direction Z. The plurality of radial ridge portions 232 are arranged at equal intervals in the circumferential direction.

Each of the plurality of radial ridge portions 232 extends in the radial direction around the winding axis a of the wound electrode assembly 10. The radial ridge portion 232 is continuous with the annular ridge portion 231.

The radial ridge portion 232 protrudes toward the first direction Z1. That is, the radial ridge portion 232 protrudes toward the wound electrode assembly 10. The radial ridge portion 232 is in contact with the negative electrode uncoated portion 111NB of the negative electrode 11N.

The plurality of welded portions 233 are portions of the bottom portion 23 that are joined to the negative electrode uncoated portion 111NB by welding. The plurality of welded portions 233 are formed by laser welding or the like from the outside of the case 20. The plurality of welded portions 233 are formed in the annular ridge portion 231. In the annular ridge portion 231, the plurality of welded portions 233 are formed so as to extend along the circumferential direction. The plurality of welded portions 233 are formed in each of the plurality of radial ridge portions 232. In the radial ridge portion 232, the welded portion 233 is formed so as to extend along the radial direction. The annular ridge portion 231 and the plurality of radial ridge portions 232 may be thinner than other portions of the bottom portion 23. This facilitates the formation of the welded portion 233.

A through-hole 23h is formed in the bottom portion 23. The through-hole 23h may be used to inject an electrolyte (not shown) contained in the case 20. The through-hole 23h is formed in the center of the bottom portion 23 when viewed from the axial direction Z.

The sealing plug 24 is inserted through the through-hole 23h of the bottom portion 23. Thus, the sealing plug 24 is fixed to the bottom portion 23. The sealing plug 24 and the through-hole 23h may function as a pressure relief valve for relieving the pressure inside the case 20 when the pressure inside the case 20 becomes excessively high.

The outer gasket 25 is disposed between the positive electrode terminal 21P and the negative electrode terminal 21N. The outer gasket 25 is made of an insulating material. Therefore, the outer gasket 25 insulates the positive electrode terminal 21P from the negative electrode terminal 21N. The outer gasket 25 covers the second direction Z2 surface of the disc portion 211. The rivet portion 212 penetrates the outer gasket 25 in the axial direction Z. The outer gasket 25 covers a radial inner surface of the through-hole 21Nh of the negative electrode terminal 21N.

The inner gasket 26 covers the second direction Z2 surface of the negative electrode terminal 21N. The inner gasket 26 is formed of an insulating material. Therefore, the inner gasket 26 insulates the wound electrode assembly 10 from the negative electrode terminal 21N. The rivet portion 212 further penetrates the inner gasket 26 in the axial direction Z. Therefore, the rivet portion 212 is exposed inside the case 20.

Next, the positive electrode current collector plate 30 will be described. As shown in FIGS. 1 and 3, the positive electrode current collector plate 30 is disposed in the case 20. The positive electrode current collector plate 30 is disposed Z1 the wound electrode assembly 10 in the first direction.

The positive electrode current collector plate 30 is provided to electrically connect the positive electrode 11P and the positive electrode terminal 21P. The positive electrode current collector plate 30 is welded to the positive electrode uncoated portion 111PB of the positive electrode 11P. As a result, the positive electrode current collector plate 30 is positively charged. The positive electrode current collector plate 30 is welded to the second direction Z2 end of the rivet portion 212 of the positive electrode terminal 21P. Accordingly, the positive electrode terminal 21P is positively charged.

An inner gasket 26 is disposed between the positive electrode current collector plate 30 and the negative electrode terminal 21N. As a result, the positive electrode current collector plate 30 and the negative electrode terminal 21N are electrically insulated from each other. The inner gasket 26 extends to the outer peripheral side of the positive electrode current collector plate 30. Accordingly, the inner gasket 26 is also disposed between the positive electrode current collector plate 30 and the cylindrical wall portion 22. Therefore, the positive electrode current collector plate 30 and the cylindrical wall portion 22 are electrically insulated from each other.

The positive electrode current collector plate 30 has a substantially disc-shaped outer shape. The positive electrode current collector plate 30 includes a central portion 31, an outer peripheral edge portion 32, a plurality of spokes 33, and a plurality of piece portions 35.

The central portion 31 is positioned so as to overlap with the rivet portion 212 of the positive electrode terminal 21P when viewed from the axial direction Z. When the central portion 31 is connected to the case 20, the positive electrode current collector plate 30 is electrically connected to the positive electrode terminal 21P. Specifically, the central portion 31 is welded to the rivet portion 212 of the positive electrode terminal 21P.

The outer peripheral edge portion 32 is provided on the outer peripheral edge of the positive electrode current collector plate 30. The outer peripheral edge portion 32 is located on the outer peripheral side of the central portion 31. The outer peripheral edge portion 32 extends in an annular shape around the central portion 31. The outer peripheral edge portion 32 may be in contact with the positive electrode uncoated portion 111PB of the positive electrode 11P. However, the outer peripheral edge portion 32 is not bonded to the positive electrode uncoated portion 111PB.

The plurality of spokes 33 are spaced apart from each other. The plurality of spokes 33 are arranged at equal intervals in the circumferential direction around the central portion 31. The spokes 33 connect the central portion 31 and the outer peripheral edge portion 32. The spoke 33 has an outer shape such that a width dimension thereof is substantially equal from the central portion 31 to the outer peripheral edge portion 32.

The plurality of piece portions 35 are spaced apart from each other. The plurality of piece portions 35 are arranged at equal intervals in the circumferential direction around the central portion 31. The plurality of spokes 33 and the plurality of piece portions 35 are arranged such that the spokes 33 and the piece portions 35 are alternately arranged in the circumferential direction around the central portion 31.

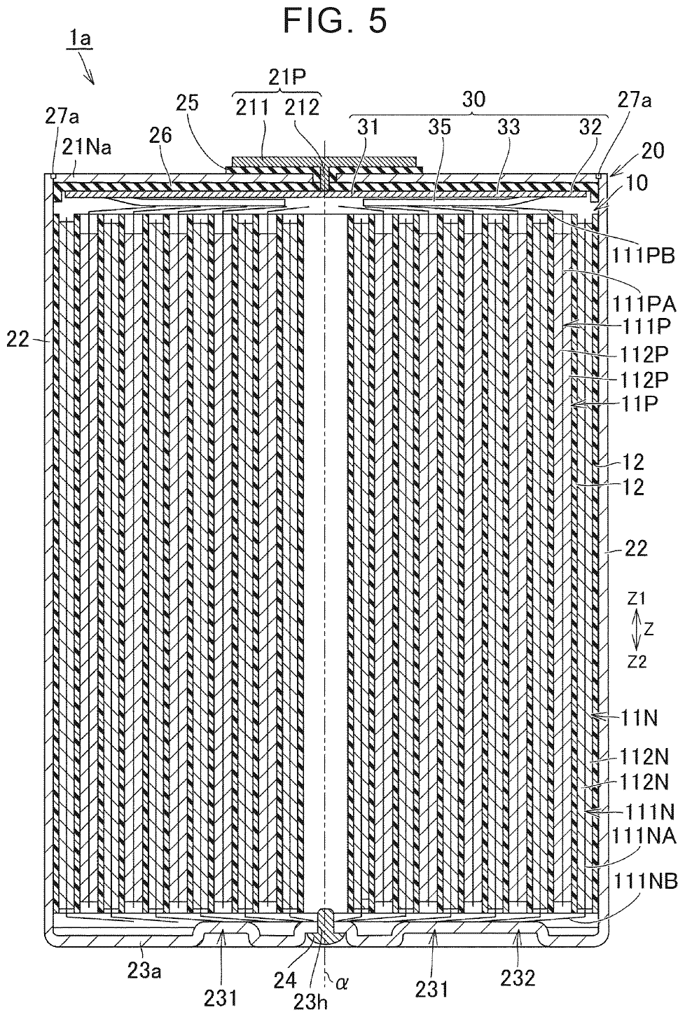

The piece portion 35 extends from the outer peripheral edge portion 32 toward the central portion 31. The piece portion 35 is connected to the positive electrode 11P. Specifically, the piece portion 35 is welded to the positive electrode uncoated portion 111PB of the positive electrode 11P. In FIG. 5, the path PP on the positive electrode current collector plate 30 from the joint portion between the piece portion 35 and the positive electrode uncoated portion 111PB to the joint portion between the central portion 31 and the rivet portion 212 is schematically illustrated.

The piece portion 35 includes a fan-shaped portion 351 and a neck portion 352. The fan-shaped portion 351 is welded to the positive electrode uncoated portion 111PB of the positive electrode 11P. The tip of the fan-shaped portion 351 faces the central portion 31. The fan-shaped portion 351 extends toward the outer peripheral edge portion 32 along two adjacent spokes 33 on both sides in the circumferential direction. As a result, the surface area of the fan-shaped portion 351 becomes relatively large, and the positive electrode 11P can be easily welded to the uncoated portion 111PB of the positive electrode.

The neck portion 352 connects the outer peripheral edge portion 32 and the fan-shaped portion 351. The neck portion 352 may be in contact with the positive electrode uncoated portion 111PB of the positive electrode 11P. However, the neck portion 352 is not bonded to the positive electrode uncoated portion 111PB of the positive electrode 11P. The dimension of the neck portion 352 in the circumferential direction is smaller than the dimension of the outer peripheral edge of the fan-shaped portion 351 in the circumferential direction. This facilitates bending of the piece portion 35 in the neck portion 352.

Here, an example of a welding method of the central portion 31 and the rivet portion 212 in the present embodiment will be described. First, prior to the central portion 31 being welded to the rivet portion 212, the fan-shaped portion 351 of the piece portion 35 is previously welded to the positive electrode uncoated portion 111PB of the positive electrode 11P. Next, the welder is inserted along the winding axis a of the wound electrode assembly 10 from the second direction Z2 of the wound electrode assembly 10. Then, while the welding device is pressed against the central portion 31 from the second direction Z2, the central portion 31 and the rivet portion 212 are welded to each other by the welding device. At this time, on the path PP, the connecting portion between the spoke 33 and the central portion 31 and the connecting portion between the spoke 33 and the outer peripheral edge portion 32 are greatly bent. As a result, the central portion 31 can be easily displaced in the axial direction Z relative to the piece portion 35. Therefore, even if the welder is pressed against the central portion 31, the joint between the piece portion 35 and the positive electrode uncoated portion 111PB is prevented from being broken due to the displacement of the central portion 31. This facilitates connection between the positive electrode current collector plate 30 and the case 20.

As described above, the power storage cell 1 according to the first embodiment of the present disclosure includes the wound electrode assembly 10 and the case 20. The wound electrode assembly 10 includes a wound negative electrode 11N and a wound positive electrode 11P. The negative electrode 11N includes a sheet-like negative electrode current collector 111N and a negative electrode mixture 112N formed on the negative electrode current collector 111N. The negative electrode current collector 111N includes a negative electrode mixture layer 112N coated negative electrode coated portion 111NA and a negative electrode uncoated portion 111NB on which the negative electrode mixture layer 112N is not coated. The negative electrode uncoated portion 111NB protrudes from the negative electrode coated portion 111NA toward one side in the axial direction Z of the wound electrode assembly 10. The case 20 houses the wound electrode assembly 10. The case 20 includes a cylindrical wall portion 22 and a bottom portion 23. The cylindrical wall portion 22 is provided so as to cover the outer peripheral side of the wound electrode assembly 10. The bottom portion 23 is disposed on one side in the axial direction Z, and is connected to one end of the cylindrical wall portion 22. The bottom portion 23 is joined to the negative electrode uncoated portion 111NB by welding from the outer side of the case 20.

According to the above configuration, the bottom portion 23 of the case 20 has a current collecting function of the negative electrode 11N. Therefore, the negative electrode 11N does not require a current collector plate that is a member other than the case 20, and the number of components of the power storage cell 1 can be reduced. As a result, the space in the case 20 in which the wound electrode assembly 10 can be accommodated is increased, and the larger wound electrode assembly 10 can be accommodated. As a result, the energy density of the power storage cell 1 is further improved.

Further, in the present embodiment, the case 20 further includes a negative electrode terminal 21N connected to the other end of the cylindrical wall portion 22 and integrally formed with the cylindrical wall portion 22. The bottom portion 23 is welded to the cylindrical wall portion 22 so that the negative electrode 11N is electrically connected to the negative electrode terminal 21N via the bottom portion 23 and the cylindrical wall portion 22.

Even when the negative electrode terminal 21N is relatively distant from the bottom portion 23 as in the above-described configuration, the negative electrode terminal 21N can be electrically connected to the negative electrode terminal 11N via the bottom portion 23 without using a member other than the case 20. As a result, the energy density of the power storage cell 1 can be increased.

### Second Embodiment

Next, a power storage cell according to a second embodiment of the present disclosure will be described. In the second embodiment of the present disclosure, a part of the configuration of the case 20 is different from the first embodiment of the present disclosure. Therefore, the same configuration and effects as those of the first embodiment of the present disclosure will not be described repeatedly.

FIG. 5 is a cross-sectional view of a power storage cell according to a second embodiment. As shown in FIG. 5, in the second embodiment, the negative electrode terminal 21Na is welded to the other end of the cylindrical wall portion 22. The bottom portion 23a is integrally formed with the cylindrical wall portion 22 so that the negative electrode 11N is electrically connected to the negative electrode terminal 21Na via the bottom portion 23a and the cylindrical wall portion 22.

Even when the external terminal (negative electrode terminal 21Na) is relatively far from the bottom portion 23a as in the above configuration, the first electrode (negative electrode terminal 21Na) can be electrically connected to the external terminal (negative electrode terminal 11N) via the bottom portion 23a without using a member other than the case 20. As a consequence, the energy-density of the power storage cell 1a can be increased. In the present embodiment, the negative electrode terminal 21Na is exemplified as an external terminal in the present disclosure.

The case 20 further includes an annular welded portion 27a. The annular welded portion 27a is formed by joining the cylindrical wall portion 22 and the negative electrode terminal 21Na to each other by laser-welding or the like. The annular welded portion 27a extends annularly along the outer peripheral edge of the negative electrode terminal 21Na when viewed from the axial direction Z.

The embodiment disclosed this time should be considered to be illustrative in all respects and not restrictive. The scope of the present disclosure is indicated by the claims rather than the description of the embodiment described above, and it is intended that all changes within the meaning and scope equivalent to the claims are included.

What is claimed is:

1. A power storage cell comprising:
a wound electrode assembly including a wound first electrode and a wound second electrode; and
a case that houses the wound electrode assembly, wherein
the first electrode includes a sheet-shaped current collector and an electrode composite material layer provided on the current collector,
the current collector includes a coated portion that is coated with the electrode composite material layer, and an uncoated portion that is not coated with the electrode composite material layer,
the uncoated portion protrudes from the coated portion to one side in an axial direction of the wound electrode assembly,
the case includes a cylindrical wall portion provided to cover an outer peripheral side of the wound electrode assembly, and a bottom portion disposed on the one side in the axial direction and connected to one end of the cylindrical wall portion, and
the bottom portion is joined to the uncoated portion by welding from an outside of the case.

2. The power storage cell according to claim 1, wherein:
the case further includes an external terminal connected to the other end of the cylindrical wall portion and integrated with the cylindrical wall portion; and
the bottom portion is joined to the cylindrical wall portion by welding to electrically connect the first electrode to the external terminal via the bottom portion and the cylindrical wall portion.

3. The power storage cell according to claim 1, wherein:
the case further includes an external terminal joined to the other end of the cylindrical wall portion by welding; and
the bottom portion is integrated with the cylindrical wall portion to electrically connect the first electrode to the external terminal via the bottom portion and the cylindrical wall portion.
